(19) United States
(12) Patent Application Publication
(10) Pub. No.: US 2020/0372528 A1
(43) Pub. Date: Nov. 26, 2020

(54) MOBILE DATA EXCHANGE

(71) Applicant: INTERNATIONAL BUSINESS MACHINES CORPORATION, Armonk, NY (US)

(72) Inventors: Corville O. Allen, Morrisville, NC (US); Kim Eric Wegner, Rochester, MN (US); Michele Chilanti, Rochester, MN (US)

(21) Appl. No.: 16/419,399

(22) Filed: May 22, 2019

(51) Int. Cl. G06Q 30/02; G06F 16/9035; G06Q 30/06

(52) U.S. Cl. CPC G06Q 30/0206; G06Q 30/0611; G06F 16/9035; G06Q 30/0208

(57) ABSTRACT

Exemplary embodiments described herein disclose a method, a computer program product, and a computer system for facilitating an exchange of data between a user and a data consumer. A computer may receive registration information of both a user and data consumer. The computer may determine a value of the user data based on source, type, quantity, post-processing cost, and inclusion of rare data types or events. The computer may be configured to provide the user an offer for the data based on the determined value, and may determine whether the user accepts the offer or provides a counteroffer. Based on determining that the user has accepted the offer or, in the alternative, that the counteroffer is acceptable, the computer may be configured to process the offered data exchange.

### BACKGROUND

The present invention relates generally to data exchange, and more particularly to bartering the exchange of information between users and data consumers.

Currently, reward systems exist for users who sign up to exchange their data with data consumers. For example, a patient may exchange their blood glucose readings with a medical device provider in exchange for supplies to take those readings. In practice, the value of the data to a data consumer may vary based on several factors, including a type of the data, a source of the data, an amount of data, a post-processing cost of the data, and a rarity of the data, among other things. However, this information is rarely available to the user, nor is a user provided a means for selectively exchanging their data with the data consumers.

### SUMMARY

Exemplary embodiments described herein disclose a method, a computer program product, and a computer system for facilitating an exchange of data between a user and a data consumer. A computer may be configured for identifying data stored on a device and determining a value of the data. In addition, the computer may be configured for presenting one or more offers to a user of the device in exchange for the data based on the value, and processing an exchange based on the user of the device accepting at least one offer of the one or more offers.

In addition, the computer may be configured for determining one or more types of the data, and wherein determining the value of the data is further based on the one or more types of data.

Moreover, the computer may be configured further for determining a source of the data, and wherein determining the value of the data is further based on the source of the data.

The computer may be further configured for determining whether the data includes one or more rare events, and wherein determining the value of the data is further based on determining that the data includes the one or more rare events.

In embodiments, the computer may be configured to additionally determining a quantity of the data, and wherein determining the value of the data is further based on the quantity of the data.

The computer may be further configured for determining a post-processing cost of the data, and wherein determining the value of the data is further based on the post-processing cost of the data.

In embodiments, determining the value of the data may further comprise weighting the data based on the one or more types of the data, the source of the data, the inclusion of one or more rare events, the quantity of the data, and the post-processing cost of the data, and aggregating the weighted data.

### BRIEF DESCRIPTION OF THE SEVERAL VIEWS OF THE DRAWINGS

The following detailed description, given by way of example and not intended to limit the invention solely thereto, will best be appreciated in conjunction with the accompanying drawings, in which:

FIG. 1 depicts a schematic diagram of a data exchange system 100, in accordance with an embodiment of the present invention.

FIG. 2 depicts a flowchart illustrating the operations of a data exchange program 146 of the data exchange system 100 in evaluating user data, in accordance with an embodiment of the present invention.

FIG. 3 depicts a flowchart illustrating the operations of a data exchange program 146 of the data exchange system 100 in facilitating the exchange of data between a user and a data consumer, in accordance with an embodiment of the present invention.

FIG. 4 depicts a block diagram depicting the hardware components of the data exchange system 100 of FIG. 1, in accordance with an example embodiment of the present invention.

FIG. 5 depicts a cloud computing environment, in accordance with an embodiment of the present invention.

FIG. 6 depicts abstraction model layers, in accordance with an embodiment of the present invention.

The drawings are not necessarily to scale. The drawings are merely schematic representations, not intended to portray specific parameters of the invention. The drawings are intended to depict only typical embodiments of the invention. In the drawings, like numbering represents like elements.

### DETAILED DESCRIPTION OF THE SEVERAL VIEWS OF THE DRAWINGS

Detailed embodiments of the claimed structures and methods are disclosed herein; however, it can be understood that the disclosed embodiments are merely illustrative of the claimed structures and methods that may be embodied in various forms. Aspects may, however, be embodied in many different forms and should not be construed as limited to the exemplary embodiments set forth herein. Rather, these exemplary embodiments are provided for thoroughness and completeness in order to fully convey a scope of these embodiments to those skilled in the art. In the description, details of well-known features and techniques may be omitted to avoid unnecessarily obscuring the presented embodiments.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

In the interest of not obscuring the presentation of exemplary embodiments described herein, in the following detailed description, some processing steps or operations that are known in the art may have been combined together for presentation and for illustration purposes and in some instances may have not been described in detail. In other instances, some processing steps or operations that are known in the art may not be described at all. It should be understood that the following description is focused on the distinctive features or elements of the various presented embodiments.

Embodiments described herein disclose a method, computer program product, and system for facilitating data exchange between a user and a data consumer. In particular, exemplary embodiments described herein allow for the real time evaluation and barter of data. Key benefits include more granular user control of their data, greater flexibility in exchanging user data, and transparent and fair compensation for their data through a flexible rather than fixed barter system. Detailed implementation follows.

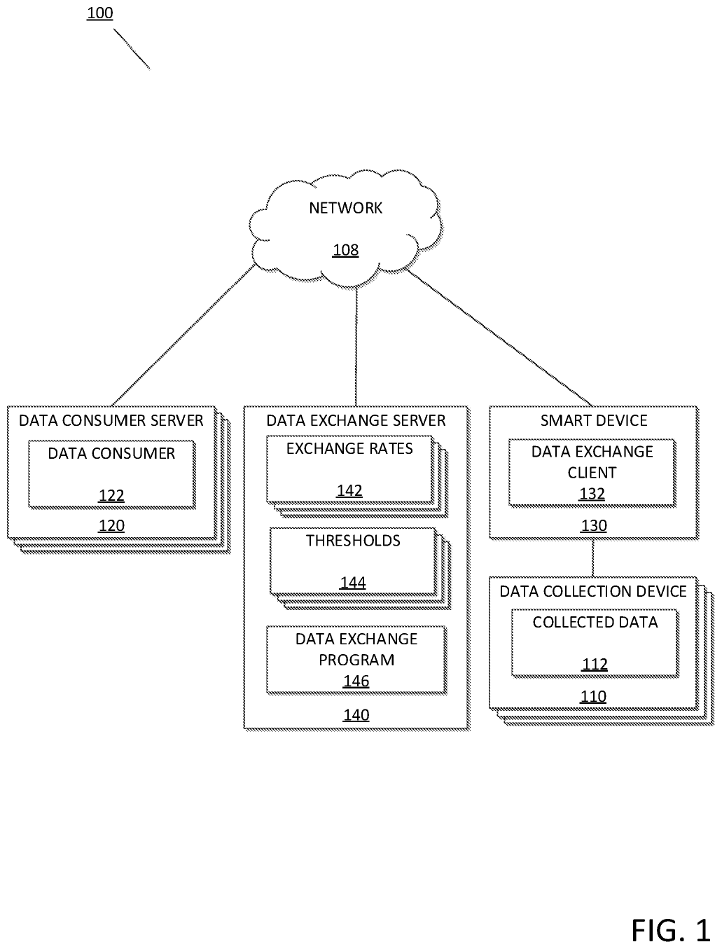

FIG. 1 depicts a data exchange system 100, in accordance with an example embodiment. The data exchange system 100 may include one or more data collection devices 110, one or more data consumer servers 120, one or more smart devices 130, and one or more data exchange servers 140, all interconnected via network 108. While, in embodiments, programming and data described herein may be stored and accessed remotely across one or more computing devices via the network 108, in other embodiments, programming and data described herein may be stored locally on as few as one physical computing device or amongst other computing devices than those depicted.

In embodiments, the network 108 may be a communication channel capable of transferring data between connected devices. For example, the network 108 may be the Internet, representing a worldwide collection of networks and gateways to support communications between devices connected to the Internet. Moreover, the network 108 may include, for example, wired, wireless, and/or fiber optic connections which may be implemented as an intranet network, a local area network (LAN), a wide area network (WAN), or a combination thereof. In further embodiments, the network 108 may be a Bluetooth network, a WiFi network, or a combination thereof. In yet further embodiments, the network 108 may be a telecommunications network used to facilitate telephone calls between two or more parties comprising a landline network, a wireless network, a closed network, a satellite network, or a combination thereof. In general, the network 108 may be any combination of connections and protocols that will support communications between connected devices.

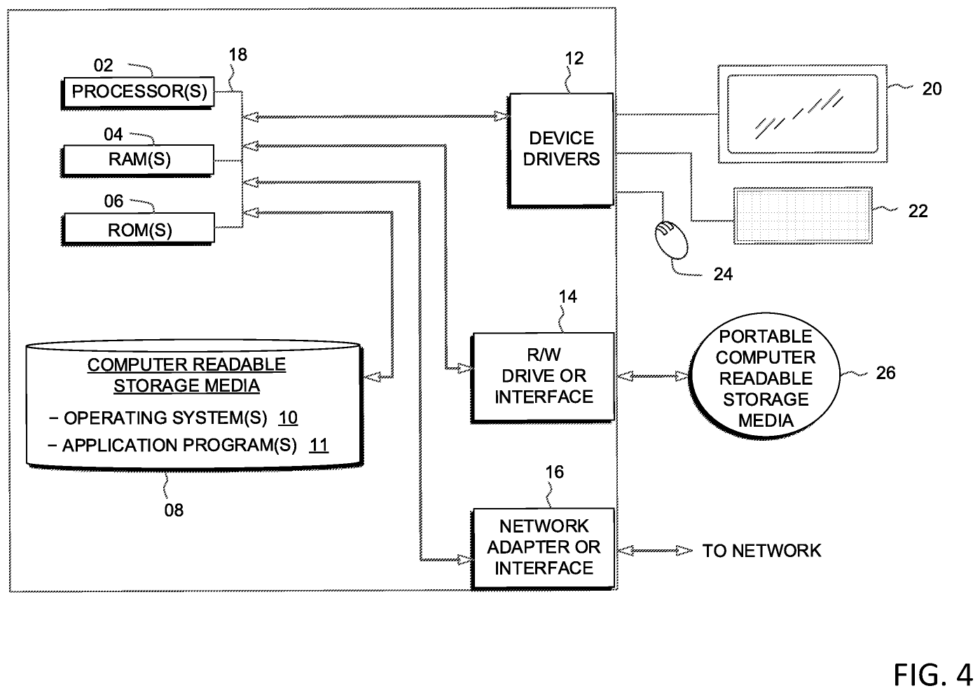

In the example embodiment, the data collection device 110 may include one or more collected data 112, and may be any device capable of collecting, storing, processing, transmitting, and/or receiving data. In embodiments, for example, the data collection device 110 may be a device within an environment, such as a smart device, appliance, sensor, camera, microphone, etc. In other embodiments, the data collection device 110 may be a wearable device, such as glasses, a contact lens, watch/wristband, ring, anklet, headband, mouthpiece, and the like. In further embodiments, the data collection device 110 may be a special purpose-device such as an insulin pen, pacemaker, catheter, meter, implantable device, etc. Moreover, in embodiments, the data collection device 110 may include computing components used for collecting, processing, aggregating, and transmitting data, for example those depicted by FIG. 4. While the data collection device 110 is shown as a single device, in embodiments, the data collection device 110 may be comprised of a cluster or plurality of computing devices, working together or working separately.

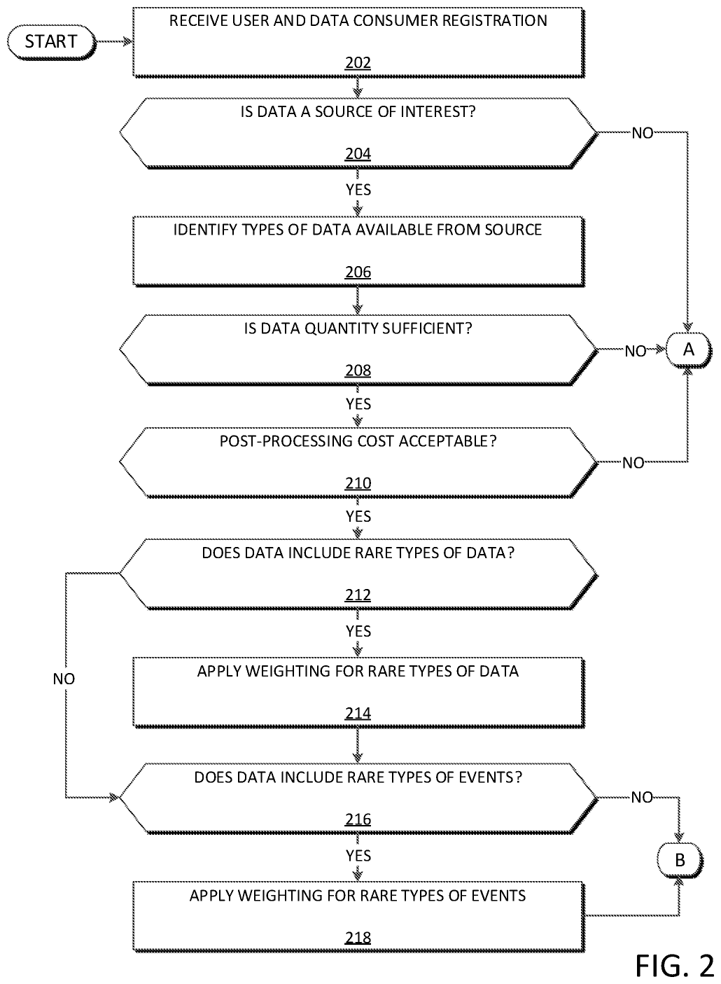

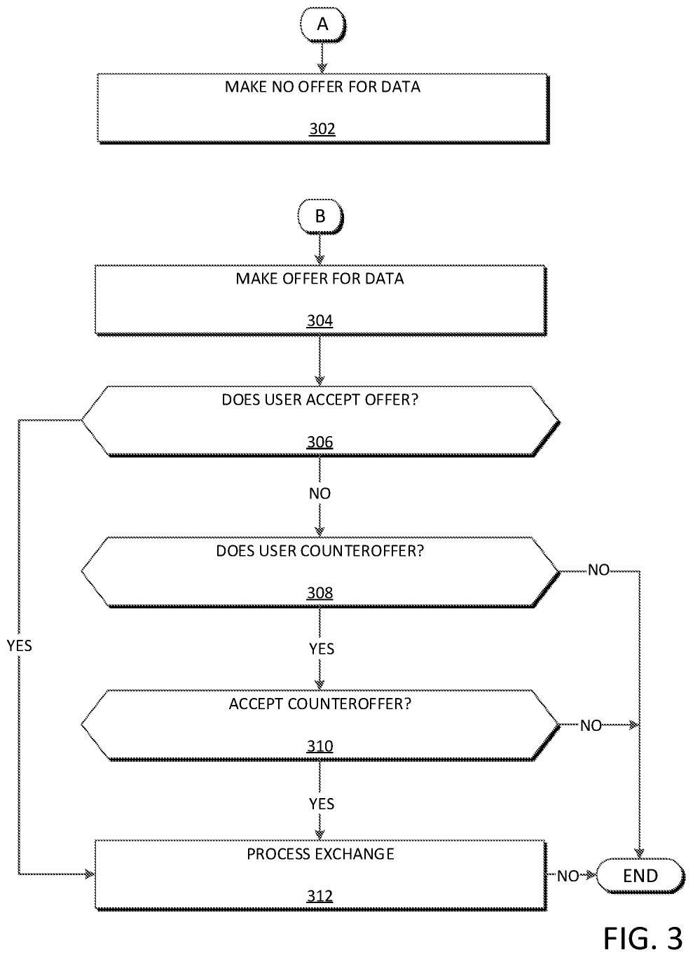

In the example embodiment, the collected data 112 may be data collected by and stored on the data collection device 110. The collected data 112 may include data contained in files, folders, and other document types and may be structured (i.e., organized into a formatted repository), partially structured, or unstructured. The collected data 112 may be written in programming languages of common file formats such as csv, .docx, .doc, .pdf, .rtf, etc. In embodiments, such data may be owned by the user of the data collection device 110, and therefore transfer of the collected data 112 may be subject to consent and privacy laws. Accordingly, the collected data 112 may be held to strict security standards and/or encrypted, when necessary. The collected data 112 is described in greater detail with respect to FIG. 2-3.

In the example embodiment, the data consumer server 120 may include one or more data consumers 122 and may be an enterprise server, a laptop computer, a notebook, a tablet computer, a netbook computer, a personal computer (PC), a desktop computer, a server, a personal digital assistant (PDA), a rotary phone, a touchtone phone, a smart phone, a mobile phone, a virtual device, a thin client, or any other electronic device or computing system capable of receiving and sending data to and from other computing devices. While the data consumer server 120 is shown as a single device, in embodiments, the data consumer server 120 may be comprised of a cluster or plurality of computing devices, working together or working separately. The data consumer server 120 is described in greater detail with reference to FIG. 4.

In the example embodiment, the data consumer 122 is an entity that utilizes user data for various purposes. For example, the data consumer 122 may be a device manufacturer, advertising company, pharmaceutical manufacturer, medical device manufacturer, hospital, research center, institution, university, insurance company, and the like. In various embodiments, the data consumer 122 provides monetary and/or nonmonetary compensation in exchange for user data, as will be described in greater detail with respect to FIG. 2-3.

In the example embodiment, the smart device 130 may include a data exchange client 132 and may be an enterprise server, a laptop computer, a notebook, a tablet computer, a netbook computer, a personal computer (PC), a desktop computer, a server, a personal digital assistant (PDA), a rotary phone, a touchtone phone, a smart phone, a mobile phone, a virtual device, a thin client, or any other electronic device or computing system capable of receiving and sending data to and from other computing devices. While the smart device 130 is shown as a single device, in embodiments, the smart device 130 may be comprised of a cluster or plurality of computing devices, working together or working separately. The smart device 130 is described in greater detail with reference to FIG. 4.

In the example embodiment, the data exchange client 132 may act as a client in a client-server relationship, and may be a software and/or hardware application capable of communicating with and providing a user interface for a user to interact with a server via the network 108. Moreover, in the example embodiment, the data exchange client 132 may be capable of transferring the collected data 112 between the data collection device 110 and other devices via the network 108. In embodiments, the data exchange client 132 utilizes various wired and wireless connection protocols for data transmission and exchange, including Bluetooth, 2.4 gHz and 5 gHz internet, near-field communication, Z-Wave, Zigbee, etc. The data exchange client 132 is described in greater detail with respect to FIG. 2-3.

In the example embodiment, the data exchange server 140 may include one or more exchange rates 142, one or more thresholds 144, and a data exchange program 146. In embodiments, the data exchange server 140 may act as a server in a client-server relationship with the data exchange client 132, and may be an enterprise server, a laptop computer, a notebook, a tablet computer, a netbook computer, a personal computer (PC), a desktop computer, a server, a personal digital assistant (PDA), a rotary phone, a touchtone phone, a smart phone, a mobile phone, a virtual device, a thin client, or any other electronic device or computing system capable of receiving and sending data to and from other computing devices. While the data exchange server 140 is shown as a single device, in embodiments, the data exchange server 140 may be comprised of a cluster or plurality of computing devices, working together or working separately. The data exchange server 140 is described in greater detail with reference to FIG. 4.

In the example embodiment, the exchange rates 142 may define exchange rates for the collected data 112 based on various features, such as data type, data source, data quantity, data post-processing costs, and data rarity. In the example embodiment, the exchange rates 142 may be defined by any of monetary currencies, credits, products, services, etc., and may be dictated by a user, the one or more data consumers 122, set costs, current market rates (supply and demand), etc. In addition, the exchange rates 142 may be further influenced by weighting applied to the collected data 112 based on the data type, source, amount, post-processing costs, and rarity, and in some cases, the post-processing cost may prove data collection uneconomical given the amount of data that is being offered. Such considerations are described in greater detail with respect to FIG. 2-3.

In the example embodiment, the thresholds 144 may indicate a quantity of the collected data 112 needed to provide insights/feedback to the data consumers 122, as some information is only valuable to the data consumer 122 if it reaches a certain threshold. For example, the collected data 112 may only be of interest to the data consumer 122 if enough data is available to generate a trend, or the collected data 112 exhibits enough data beyond a particular anomalous threshold. In the example embodiment, the thresholds 144 may be set by a user, the one or more data consumers 122, statistical standards/benchmarks, and the like. The thresholds 144 are described in greater detail with reference to FIG. 2-3.

The data exchange program 146 is a software and/or hardware application that may be configured to facilitate the exchange of data between a user and a data consumer, as will be described in greater detail with reference to FIG. 2-3. In the example embodiment, the data exchange program 146 may be configured to receive registration information of both a user and data consumer, as well as determine whether data of the user is gathered from a source of interest. Based on determining that the user data is gathered from a source of interest, the data exchange program 146 may be configured to identify the types of data available from the source of interest and determine whether a quantity of the data is sufficient. Based on determining that the quantity of the data is sufficient, the data exchange program 146 may be configured to determine whether a cost of post-processing the user data is acceptable and, based on a positive determination, determine whether the data includes any rare types of data. Based on determining that the data includes one or more rare types of data, the data exchange program 146 may be configured to apply weights to the included rare types of data and determine whether the data includes any rare events. Based on a positive determination, the data exchange program 146 may be configured to apply weights to the included rare types of events. In embodiments, the data exchange program 146 may be configured to provide the user an offer for the data based on the source, type(s), amount, post-processing cost, and rarity, and determines whether the user accepts the offer or provides a counteroffer. Lastly, based on determining that the user has accepted the offer or, in the alternative, that the counteroffer is acceptable, the data exchange program 146 may be configured to process the offered data exchange.

FIG. 2 illustrates the operations of the data exchange program 146 of the data exchange system 100 in evaluating user data, in accordance with an exemplary embodiment.

The data exchange program 146 may receive user and data consumer registration information (step 202). In the example embodiment, the data exchange program 146 receives registration information of both users and the data consumer(s) 122 in order to identify the data contained in the collected data 112 and the smart device 130, as well as identify data of interest to the one or more data consumers 122. In terms of user information, the data exchange program 146 receives demographic information, such as a name, age, gender, location, contact information, and the like, with this information being anonymized as needed based on data privacy and data right concerns. Moreover, the data exchange program 146 may also receive from the user information relevant to the services or industry to which they are offering their collected data 112. For example, a user that wishes to exchange medical information with a medical device manufacturer may further include their health conditions, such as diagnose(s) information, current medical devices used, types of data extracted by the medical devices, and the like, described in greater detail forthcoming. While it is not necessary for the data exchange program 146 to extract the collected data 112 from the data collection device 110 or the smart device 130 at this time, some embodiments may configure the data exchange program 146 to extract the collected data 112 at the time of registration, on demand, and/or at subsequent intervals. In such embodiments, the data exchange program 146 may be configured to automatically retrieve the collected data 112, for example securely extracting the data from the data collection device 110/the smart device 130, referencing a user record/profile, referencing claim data, or receiving user-uploaded data. In other embodiments, however, the data exchange program 146 may be configured to only transfer the collected data 112 once an exchange is agreed upon.

In addition, the data exchange program 146 may further receive registration information from the data consumer 122 (step 202 continued). In the example embodiment, the data consumer registration information may include consumer demographics like above, but also information relating to data of interest, such as desired sources of the data, desired types of the data (from particular sources), sufficient amounts (thresholds) of the data (in total or by type), rarity of the data (by source, type, and occurrence), events of interest, and the like. Note that for particular requests, the data consumer 122 may be required to include definitions as to what constitutes rare occurrences and/or events of interest using code or a descriptive string. In addition to registering data of interest, the data consumer 122 may further include information regarding post-processing costs of the information based on type, amount, rarity, etc. such that the data exchange program 146 may determine whether an exchange is economical given a cost of post-processing compared to a cost to acquire the collected data 112 from the user. Moreover, the data exchange program 146 may receive a maximum compensation the data consumer 122 is willing to provide in exchange for said collected data 112, which may then be used to populate the exchange rates 142. Similarly, the data exchange program 146 may populate the thresholds 144 with the threshold amounts of data needed for analysis provided by the data consumer 122 based on data source, type, etc. In embodiments, the data exchange program 146 may further receive from the data consumer 122 preferred user groups, frequency of exchange, etc.

To further illustrate the operations of the data exchange program 146, reference is now made to an illustrative example where the data exchange program 146 receives registration information from a patient wishing to exchange medical data. In this example, the patient is a 54 year old male suffering from diabetes, heart failure, and carpel tunnel. The patient utilizes an insulin pen to monitor blood-glucose readings five times a day, a left ventricular assist device (LVAD) and implantable cardioverter-defibrillator (ICD) to assist/monitor cardiac function, and a wearable wrist device to manage carpel tunnel. In addition, a medical device manufacturer registers as a data consumer 122 seeking blood glucose data types from insulin pens pertaining to blood-glucose readings and pump rate data types from heart-related devices pertaining to cardiac function readings. The medical device manufacturer further indicates that a sufficient amount of blood-glucose data is at least three blood-glucose readings per day and a sufficient amount of readings from the LVAD and ICD is at least once every hour. The medical device manufacturer registration further includes exchange rates for the data of interest and maximum tolerances of the exchange rates, as well as processing rates and maximum acceptable processing costs. Lastly, the medical device manufacturer specifies that rare types of data include any taken from cardiac devices, and rare events of interest include an inappropriate shock from an ICD. This includes the heart-rate data type and the shock event for that rare event, and this type of event may calculated based on the value(s) of the data by the combination of data points if the device does not explicitly identify the inappropriateness.

The data exchange program 146 determines whether the source of the collected data 112 is a source of interest (decision 204). In the example embodiment, a data source may be represented by the data collection device 110 and the data exchange program 146 may determine whether the collected data 112 is collected by a source of interest by cross-referencing the data collection device 110 registered by the user with data sources requested by the data consumer 122 at registration. As some of the data consumers 122 may be interested in different sources and types of the collected data 112, the data exchange program 146 may be configured to receive from the data consumer 122 at registration the data sources and types in which it has interest. Moreover, because a value of the collected data 112 may vary based on the source, the data exchange program 146 may be configured to weight those sources having information more desirable to the data consumers 122. For example, the sources may be weighted on a scale of one through five with a one indicating a baseline value and a weight of up to five indicating a higher value. Based on determining that the collected data 112 is gathered by a source of interest, the data exchange program 146 determines that the source of the collected data 112 is a source of interest.

With reference again to the previously introduced example, the data exchange program 146 cross-references the insulin pen, LVAD, ICD, and wearable wrist device of the patient with the desired data sources of insulin pens and cardiac function devices listed by the medical device manufacturer at registration to determine that medical data pertaining to the blood-glucose level and cardiac circulation measurements are collected from sources of interest, namely the insulin pen, LVAD, and ICD. Note that in this example, data from the wearable wrist device is not determined to be from a source of interest because no data consumer requested such data and, accordingly, the data may be excluded from the exchange.

Based on determining that the data source of the data is a source of interest (decision 204, “YES” branch), the data exchange program 146 may determine one or more types of data available from the source (step 206). In the example embodiment, one or more data types may refer to one or more particular measurements, for example a blood-glucose, pump rate, or heart beat per minute measurement. In addition, the data types may further include exercise measurements, such as steps per day and calories burned. Like the data sources described above, particular data types may be similarly weighted such that those imputing more value to the data consumer 122 are weighted accordingly by the data exchange program 146.

Referring now to the previously introduced illustrative example, the data exchange program 146 determines that the collected data 112 includes data types of interest to the medical device manufacturer that include blood-glucose readings of the insulin pen and pump rate of the LVAD and ICD.

The data exchange program 146 may determine whether an amount of the collected data 112 is sufficient (decision 208). As was previously noted, the collected data 112 may only be valuable if it is collected in sufficient amounts, for example amounts sufficient to establish trends or for analysis to provide meaningful insights. Accordingly, the data exchange server 140 maintains the one or more thresholds 144 which delineate a sufficient amount of the collected data 112 for meaningful analysis of each of the identified data types. In the example embodiment, the thresholds 144 are derived from registration information of the user and the data consumer 122, however in other embodiments can be derived from other sources, such as set minimum amounts, statistical standards/benchmarks, comparison to other similar metrics, and the like. Accordingly, in the example embodiment, the data exchange program 146 determines whether an amount of the data is sufficient by comparing an amount of the collected data 112 to the thresholds 144 for each of the data types identified. In addition to determining whether an amount of the collected data 112 is sufficient, the data exchange program 146 may further weight the collected data 112 based on the amount in a similar manner to that described above, with greater weight being applied to the collected data 112 having amounts sufficient to provide greater value.

With reference again to the illustrative example, the data exchange program 146 compares the five blood-glucose readings per day of the patient with the three readings per day required by the medical device manufacturer to determine that the blood-glucose data quantity is not only sufficient, but in surplus. Accordingly, the blood-glucose data may be weighted additionally. Similarly, the data exchange program 146 compares an amount of cardiac readings of the LVAD and ICD of the patient with the once per hour requirement of the medical device manufacturer to determine that the cardiac function data quantity is sufficient.

Based on determining that the amount of the data is sufficient (decision 208, “YES” branch), the data exchange program 146 may determine whether a post-processing cost of the collected data 112 is acceptable (decision 210). In the example embodiment, the data exchange program 146 determines whether a post-processing cost is acceptable by first determining a post-processing cost of the collected data 112. Here, where the data consumer 122 has provided a cost rate per data type, amount, post-processing operation (validation, sorting, aggregating, classifying, etc.), etc. at registration, the data exchange program 146 may simply compare the maximum rate to an acquisition cost. Alternatively, the data exchange program 146 may determine a total post-processing cost by multiplying the post-processing rates by the data types and data quantities available, then comparing the total post-processing cost to a maximum total post-processing cost. If the total post-processing cost is less than the registered maximum cost, the data exchange program 146 determines that the post-processing costs are acceptable.

Returning to the previously introduced example, the data exchange program 146 compares a rate to post-process the blood-glucose data to an acquisition cost of the blood-glucose data. Similarly, the data exchange program 146 compares a rate to post-process the cardiac function data to an acquisition cost of the cardiac function data.

Based on determining that the cost of post-processing the data is acceptable (decision 210, “YES” branch), the data exchange program 146 may determine whether the data includes one or more rare types of data (decision 212). Rare types of data may include data types that are uncommon, for example unexpected or outlier results, as well as the collected data 112 that is gathered by rare sources, such as an uncommon medical device (e.g., artificial heat). Alternatively, rare types of data may include a set of data values and types in a time period that is designated as a rare event. In the example embodiment, the data exchange program 146 determines whether the data includes any rare types by comparing the collected data 112 to the registration information of the data consumer 122, namely the information regarding rare types of data. Such rare sources of the collected data 112 are valued more by the data consumer 122 due to their scarcity, and therefore the data exchange program 146 may be configured to additionally weight the collected data 112 in a similar manner to that above.

With reference to the previously introduced example, the data exchange program 146 compares the patient data to the registration information of the medical device manufacturer to determine that the data includes medical data from the rare sources of an LVAD and ICD.

Based on determining that the data includes one or more rare types of data (decision 212 “YES” branch), the data exchange program 146 may apply a weighting to the one or more rare types of data (step 214) Like the weighting described above, the weights are indicative of a value of the collected data 112 and a greater weight indicates greater perceived value.

Continuing the example above, the data exchange program 146 applies a weight to the data gathered by the LVAD and ICD.

Following the application the weights to the one or more rare types of data (step 214) or determining that the data does not include any rare types of data (decision 212, “NO” branch), the data exchange program 146 may determine whether the data includes one or more rare types of events (decision 216). Similar to the rare data types described above, rare events may include uncommon phenomena, anomalous behaviour, unexpected results, a combination of data values of a particular type that exceeds normal readings and are inter-related, a particular combination of device types used by a particular user, missing data related to a device and corresponding status values, and other scenarios where the collected data 112 for such is less available and more difficult to obtain. In the example embodiment, the data exchange program 146 determines whether the data includes any rare events by comparing the collected data 112 to the registration information of the data consumer 122, namely the information regarding rare events of data.

Furthering the earlier introduced example, the data exchange program 146 compares the patient data to the registration information of the medical device manufacturer to determine that the patient data includes a rare event of an inappropriate shock to an arrythmia.

Based on determining that the data includes one or more rare types of events (decision 216 “YES” branch), the data exchange program 146 may apply a weighting to the one or more rare types of events (step 218). In the example embodiment, a greater weight is applied to more rare events while a lesser weight or no weight at all is applied to more common events.

With reference again to the example, the data exchange program 146 applies a weight to the data indicating an abnormal shock by the ICD.

Referring now to FIG. 3, if the data exchange program 146 determines that the source of the data is not of interest (decision 204, “NO” branch), that the data quantity is insufficient (decision 208, “NO” branch), or that the post-processing cost of the data is unacceptable (decision 210, “NO” branch), then the data exchange program 146 makes no offer to the user for the data (step 302). Here, the data exchange program 146 has determined that the collected data 112 is not suitable for exchange, and opts not to make an offer to the user. Subsequently, the data exchange program 146 ends or, alternatively, returns to FIG. 2 to restart the process.

In a second example, if a patient lacks any information of interest of to the data consumer 122, the data exchange program 146 ends and wait for the upload of new collected data 112 or registration information.

Following the application of weights to the one or more rare types of events (step 218) or determining that the data does not include any rare events (decision 216, “NO” branch), the data exchange program 146 may provide an offer to the user for the collected data 112 of interest (step 304). In the example embodiment, the data exchange program 146 bases the offer on a matrix of the data source, data type, data amount, post-processing costs, data type rarity, and event occurrence rarity, including any weights applied thereto. Based on the data source, type, amount, post-processing costs, type rarity, and event rarity, the data exchange program 146 determines and offers a fair value to the user in exchange for the collected data 112 of interest. In the example embodiment, the offer is provided to the user via the data exchange client 132 in the form of push notification, email, text, etc. In addition to the offer itself, the data exchange program 146 may further display to the user other relevant information regarding their collected data 112 of interest, including whether the types of the collected data 112 are more valuable than average, whether the amount of the collected data 112 qualifies the user for additional compensation, and whether the collected data 112 displays any unique data or events. Note that with regard to the unique events, discretion must be maintained as to not alarm or disturb the user in the event of particularly rare and/or dangerous occurrences.

Referring back to the former example, the data exchange program 146 provides the patient receives an offer for the blood-glucose data and cardiac function data, along with an indication of how valuable the data is relative to other and average medical data. In addition, the data exchange program 146 indicates how much more data is needed for additional compensation, as well as any unique data or events included in the collected data 112 of interest.

The data exchange program 146 may determine whether the user accepts the provided offer (decision 306). In response to the offer, the data exchange program 146 provides the patient selectable options, for example buttons, drop down menus, toggle bars, radial buttons, etc., used for acting on the provided offer, for example to accept or decline. In addition to accepting or declining an offer, the data exchange program 146 may further incorporate an option for the user to provide a counteroffer. In such embodiments, the user may enter the counteroffer into a blank text field, adjust the provided offer with up/down arrows, remover particular data from the collected data 112 of interest, add additional collected data 112, and the like.

In yet further embodiments, a user may select an option indicating that the user would prefer not to be presented offers, but rather have the data exchange program 146 accept reasonable offers on behalf of the user in an automated fashion (decision 306 continued). In embodiments enabling this automated fashion, the user may specify which data, if not all, that is subject to automatic exchange and, alternatively, which data the patient may prefer to evaluate personally. In addition, a patient may prescribe upper and lower bounds (tolerances) of a fixed or variable baseline cost corresponding to different sources, types, amounts, rarities, etc. of the collected data 112 and the data exchange program 146 may only accept offers falling within the tolerances. In yet further embodiments, the data exchange program 146 may facilitate the messaging of text between a user and the data consumer 122, enabling real-time negotiations via chat, email, etc. for not only monetary compensation, but products/devices, services, and the like. It will be appreciated that various user interfaces and functionality may be incorporated into the data exchange client 132 to facilitate the aforementioned exchange.

Furthering the formerly introduced example, the data exchange program 146 determines whether the patient has accepted the provided offer via communication with the data exchange client 132.

If the data exchange program 146 determines that the user has not accepted the offer (decision 306, “NO” branch), then the data exchange program 146 may determine whether the user has provided a counteroffer (decision 308). In the example embodiment, the data exchange program 146 may determine whether the user has provided a counteroffer via communication with the data exchange client 132 of the smart device 130.

Referring to the example above, the data exchange program 146 determines whether the patient has selected an option to provide a counteroffer.

If the data exchange program 146 determines that the user has provided a counteroffer (decision 308, “YES” branch), then the data exchange program 146 may determine whether to accept the provided counteroffer (decision 310). In the example embodiment, the data exchange program 146 may be configured to accept counteroffers within prescribed ranges of the evaluation of the collected data 112 based on the exchange rates 142. For example, the data exchange program 146 may accept offers within a certain percentage of the offer, for example +/−10%. Similarly, the data exchange program 146 may be configured to have hard caps at rates per data source, type, amount, rarity, etc. In further embodiments, the counteroffer may be compared to maximum compensation values provided by the data consumer 122 during the registration process. In embodiments where the user counteroffer takes the form of text, the data exchange program 146 may act as an intermediary for dialogue between the user and the data consumer 122.

Furthering the example above, the data exchange program 146 compares the provided counteroffer to the acceptable tolerances of +/−10% of the exchange rate.

If the data exchange program 146 determines that the user has accepted the offer (decision 306, “YES” branch) or that the provided counteroffer is acceptable (decision 310, “YES” branch), then the data exchange program 146 processes the exchange (step 312). In the example embodiment, the data exchange program 146 securely extracts the collected data 112 of interest from the smart device 130 or the data collection device 110 via the data exchange client 132, then transmits the collected data 112 of interest to the data consumer server 120 via the network 108. The data exchange program 146 may then forward the collected data 112 of interest to the data consumer(s) 122.

In the example above, if the patient accepts the original offer or the data exchange program 146 determines that a counteroffer falls within the maximum cost tolerance indicated by the medical device manufacturer, the data exchange program 146 processes the exchange, providing compensation to the patient and medical data to the medical device manufacturer.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

FIG. 4 depicts a block diagram of devices within the data exchange system 100 of FIG. 1, in accordance with an embodiment of the present invention. It should be appreciated that FIG. 4 provides only an illustration of one implementation and does not imply any limitations with regard to the environments in which different embodiments may be implemented. Many modifications to the depicted environment may be made.

Devices used herein may include one or more processors 02, one or more computer-readable RAMs 04, one or more computer-readable ROMs 06, one or more computer readable storage media 08, device drivers 12, read/write drive or interface 14, network adapter or interface 16, all interconnected over a communications fabric 18. Communications fabric 18 may be implemented with any architecture designed for passing data and/or control information between processors (such as microprocessors, communications and network processors, etc.), system memory, peripheral devices, and any other hardware components within a system.

One or more operating systems 10, and one or more application programs 11 are stored on one or more of the computer readable storage media 08 for execution by one or more of the processors 02 via one or more of the respective RAMs 04 (which typically include cache memory). In the illustrated embodiment, each of the computer readable storage media 08 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Devices used herein may also include a R/W drive or interface 14 to read from and write to one or more portable computer readable storage media 26. Application programs 11 on said devices may be stored on one or more of the portable computer readable storage media 26, read via the respective R/W drive or interface 14 and loaded into the respective computer readable storage media 08.

Devices used herein may also include a network adapter or interface 16, such as a TCP/IP adapter card or wireless communication adapter (such as a 4G wireless communication adapter using OFDMA technology). Application programs 11 on said computing devices may be downloaded to the computing device from an external computer or external storage device via a network (for example, the Internet, a local area network or other wide area network or wireless network) and network adapter or interface 16. From the network adapter or interface 16, the programs may be loaded onto computer readable storage media 08. The network may comprise copper wires, optical fibers, wireless transmission, routers, firewalls, switches, gateway computers and/or edge servers.

Devices used herein may also include a display screen 20, a keyboard or keypad 22, and a computer mouse or touchpad 24. Device drivers 12 interface to display screen 20 for imaging, to keyboard or keypad 22, to computer mouse or touchpad 24, and/or to display screen 20 for pressure sensing of alphanumeric character entry and user selections. The device drivers 12, R/W drive or interface 14 and network adapter or interface 16 may comprise hardware and software (stored on computer readable storage media 08 and/or ROM 06).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Based on the foregoing, a computer system, method, and computer program product have been disclosed. However, numerous modifications and substitutions can be made without deviating from the scope of the present invention. Therefore, the present invention has been disclosed by way of example and not limitation.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

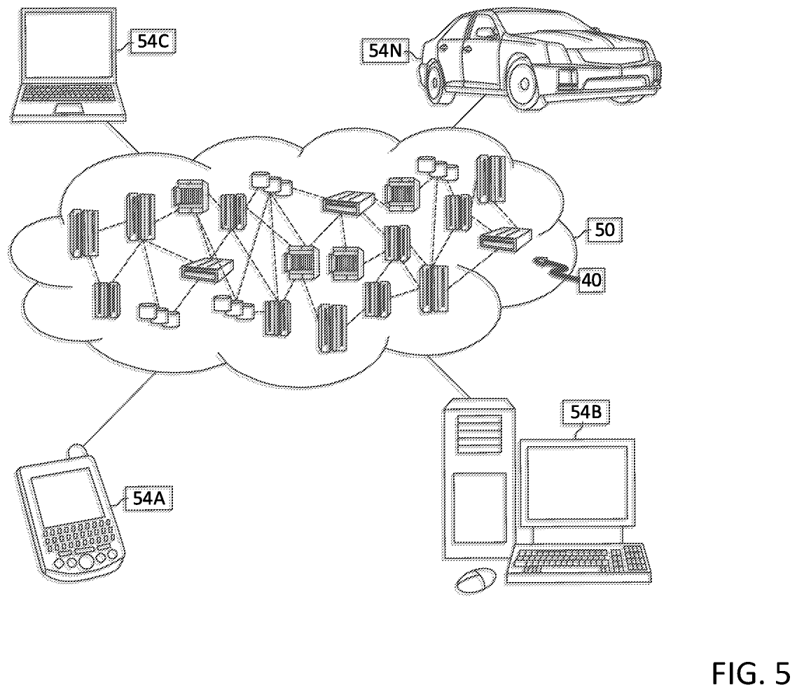

Referring now to FIG. 5, illustrative cloud computing environment 50 is depicted. As shown, cloud computing environment 50 includes one or more cloud computing nodes 40 with which local computing devices used by cloud consumers, such as, for example, personal digital assistant (PDA) or cellular telephone 54A, desktop computer 54B, laptop computer 54C, and/or automobile computer system 54N may communicate. Nodes 40 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 40 and cloud computing environment 50 can communicate with any type of computerized device over any type of network and/or network addressable connection (e.g., using a web browser).

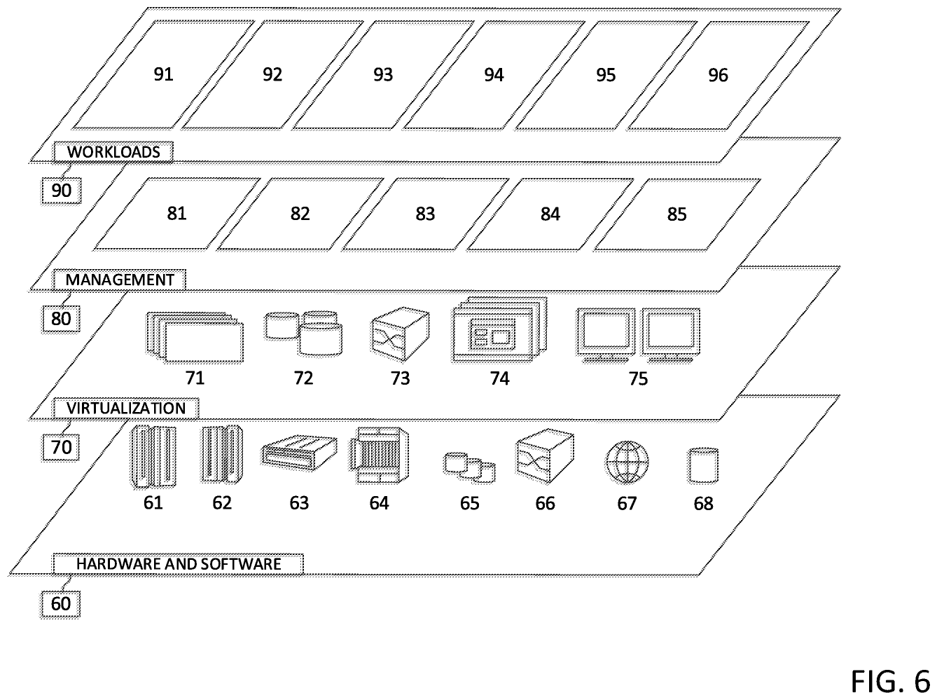

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and exchange processing 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method for facilitating an exchange of data between a user and a data consumer, the method comprising:
identifying data stored on a device;
determining a source of the data;
determining a value of the data, wherein determining the value of the data is based on different types of sources of the data;
presenting one or more offers to a user of the device in exchange for the data based on the value; and
processing an exchange based on the user of the device accepting at least one offer of the one or more offers.

2. The method of claim 1, further comprising:
determining one or more types of the data; and
wherein determining the value of the data is further based on the one or more types of data.

3. (canceled)

4. The method of claim 1, further comprising:
determining whether the data includes one or more rare events; and
wherein determining the value of the data is further based on determining that the data includes the one or more rare events.

5. The method of claim 1, further comprising:
determining a quantity of the data; and
wherein determining the value of the data is further based on the quantity of the data.

6. The method of claim 1, further comprising:
determining a post-processing cost of the data; and
wherein determining the value of the data is further based on the post-processing cost of the data.

7. The method of claim 6, wherein determining the value of the data further comprises:
weighting the data based on the one or more types of the data, the source of the data, the inclusion of one or more rare events, the quantity of the data, and the post-processing cost of the data; and
aggregating the weighted data.

8. A computer program product for facilitating an exchange of data between a user and a data consumer, the computer program product comprising:
one or more non-transitory computer-readable storage media and program instructions stored on the one or more non-transitory computer-readable storage media capable of performing a method, the method comprising:
identifying data stored on a device;
determining a source of the data;
determining a value of the data, wherein determining the value of the data is based on different types of sources of the data;
presenting one or more offers to a user of the device in exchange for the data based on the value; and
processing an exchange based on the user of the device accepting at least one offer of the one or more offers.

9. The computer program product of claim 8, further comprising:
determining one or more types of the data; and
wherein determining the value of the data is further based on the one or more types of data.

10. (canceled)

11. The computer program product of claim 8, further comprising:
determining whether the data includes one or more rare events; and
wherein determining the value of the data is further based on determining that the data includes the one or more rare events.

12. The computer program product of claim 8, further comprising:
determining a quantity of the data; and
wherein determining the value of the data is further based on the quantity of the data.

13. The computer program product of claim 8, further comprising:
determining a post-processing cost of the data; and
wherein determining the value of the data is further based on the post-processing cost of the data.

14. The computer program product of claim 8, wherein determining the value of the data further comprises:
weighting the data based on the one or more types of the data, the source of the data, the inclusion of one or more rare events, the quantity of the data, and the post-processing cost of the data; and
aggregating the weighted data.

15. A computer system for facilitating an exchange of data between a user and a data consumer, the computer system comprising:
one or more computer processors, one or more computer-readable storage media, and program instructions stored on one or more of the computer-readable storage media for execution by at least one of the one or more processors capable of performing a method, the method comprising:
identifying data stored on a device;
determining a source of the data;
determining a value of the data, wherein determining the value of the data is based on different types of sources of the data;
presenting one or more offers to a user of the device in exchange for the data based on the value; and
processing an exchange based on the user of the device accepting at least one offer of the one or more offers.

16. The computer system of claim 15, further comprising:
determining one or more types of the data; and
wherein determining the value of the data is further based on the one or more types of data.

17. (canceled)

18. The computer system of claim 15, further comprising:
determining whether the data includes one or more rare events; and
wherein determining the value of the data is further based on determining that the data includes the one or more rare events.

19. The computer system of claim 15, further comprising:
determining a quantity of the data; and
wherein determining the value of the data is further based on the quantity of the data.

20. The computer system of claim 15, further comprising:
determining a post-processing cost of the data; and
wherein determining the value of the data is further based on the post-processing cost of the data.
